(19) United States
(12) Patent Application Publication
(10) Pub. No.: US 2013/0279359 A1
(43) Pub. Date: Oct. 24, 2013

(54) METHOD FOR MEASURING CHANNEL STATE INFORMATION, UE AND BASE STATION

(71) Applicant: Fujitsu Limited, Kawasaki-shi (JP)

(72) Inventors: Yuantao ZHANG, Beijing (CN); Yi ZHANG, Beijing (CN); Yi WANG, Beijing (CN); Hua ZHOU, Beijing (CN); Jianming WU, Beijing (CN)

(21) Appl. No.: 13/921,356

(22) Filed: Jun. 19, 2013

Related U.S. Application Data
(63) Continuation of application No. PCT/CN2011/070959, filed on Feb. 12, 2011.

(51) Int. Cl. H04W 24/00

(52) U.S. Cl. CPC H04W 24/00
USPC 370/252

(57) ABSTRACT

A method for measuring channel state information, a UE and base station are described. The method includes: receiving in a subframe of Pico cell, by the user equipment, the channel state information reference symbol or common reference symbol of the Pico cell, the subframe of Pico cell corresponding to an almost blank subframe in a measurement set; and measuring the channel state information of the Pico cell based on the channel state information reference symbol or common reference symbol of the Pico cell. In certain embodiments, the UE configured with coordinated multi-point mode may measure the CSI of the Macro cell and the Pico cell without muting or with decreased muting by using the measurement set, thereby overcoming or partially overcoming the problems brought by RE muting.

### CROSS-REFERENCE TO RELATED APPLICATIONS

The present application is a continuation of PCT Application No. PCT/CN2011/070959, now pending, filed on Feb. 12, 2011, the contents of which are herein wholly incorporated by reference.

### TECHNICAL FIELD

The present invention relates to the field of communication, and in particular to a method for measuring channel state information, UE and base station.

### BACKGROUND ART

In order to further improve the capacity of a system, a heterogeneous network is introduced into the long-term evolution-advance (LTE-A) scheme of the next generation radio communication system. An LTE-A system may consist of a Macro cell, a femto-cell, a Pico cell, a remote radio head (RRH) and a relay. By deploying new radio nodes, such a scheme not only improves the capacity of the system, but also provides better services to subscribers in special areas and optimizes the performance of the system. On the other hand, the newly-deployed nodes will bring interference to the originally-deployed cell subscribers, even resulting in some coverage holes. Therefore, a method of enhanced inter-cell interference coordination (eICIC) is needed to further optimize the performance of the system.

FIG. 1 schematically shows interference in a heterogeneous network. As shown in FIG. 1, in a typical Macro cell plus Pico cell (in this application, this term comprises a femto-cell, and a Pico cell, etc.) heterogeneous network, as indicated by the left dotted arrow in FIG. 1, the user equipment (UE) at an edge of the Pico cell receiving the Pico cell services is subject to the interference of the downlink signals from the Macro cell; and on the other hand, as indicated by the right dotted arrow in FIG. 1, the UE of the Macro cell is also subject to the interference of the uplink signals from the UE of the Pico cell.

On the other hand, coordinated multi-point (CoMP) technique has been determined as an alternative technique in next version Rel. 11 of LTE. FIG. 2 schematically shows a typical CoMP structure. As shown in FIG. 2, if UE has been configured with a CoMP mode, which may a CoMP transmission mode or a CoMP feedback mode, it will generally obtain services from other cells than its cell.

In general, the serving base station of such type of UE configures the UE with a plurality of base stations, and the UE needs to measure channel station information (CSI) of each base station. Such CSI is generally measured by corresponding reference signal (RS), such as a channel station information reference symbol (CSI-RS). Generally speaking, a certain base station is orthogonal to its neighboring base stations, and such orthogonality may be realized in a time domain, a frequency domain, a time and frequency domain or a code domain, etc.

Furthermore, in order that UE configured as CoMP correctly measures the channel quality of each cell, a scheme referred to as resource element (RE) muting is usually adopted. In an orthogonal frequency division multiplexing (OFDM) system, such an RE generally refers to an OFDM subcarrier. The so-called muting refers to that at positions where other cells transmit CSI-RSs, the RE to which the serving cell corresponds does not transmit any data.

FIG. 3 schematically shows typical muting. As shown in FIG. 3, at the position where the cell #1 transmits CSI-RSs, REs to which the cell#2 and cell#3 correspond do not transmit any data; at the position where the cell #2 transmits CSI-RSs, REs to which the cell#1 and cell#3 correspond do not transmit any data; and at the position where the cell #3 transmits CSI-RSs, REs to which the cell#1 and cell#2 correspond do not transmit any data. As no data is transmitted at a corresponding position, the use of RE muting may improve the accuracy of measurement of CSI of other cells by the UE.

However, in the implementation of certain embodiments herein, the inventors found that other defects are introduced due to the RE muting in a heterogeneous network. For example:

(1) from the point of view of the serving cell, the overhead of serving cell is increased, that is, it corresponds to that the number of the REs in the serving cell for transmitting CSI-RSs is increased doubly; and

(2) for UE scheduled in a resource block (RB) containing CSI-RSs, if the UE is an apparatus of LTE Rel. 8 or Rel. 9, the UE is unaware that the RB contains muting REs and performs receiving as in normal cases where there are data, the error probability in decoding will be greatly increased.

It should be noted that the above introduction to the background art is only for clear and complete explanation of the certain technical solution of several embodiments herein, and for the understanding by those skilled in the art. It should not be construed that the above technical solution is known to those skilled in the art as it is described in the background art.

### SUMMARY

Several embodiments herein provide a method for measuring channel state information of a Macro cell and a Pico cell, UE and base station, with an object being to overcome or partially overcome the problems brought by RE muting in a heterogeneous network.

According to one aspect of the some embodiments, a method for measuring channel state information is provided, which is applied for user equipment configured with coordinated multi-point mode in a Macro cell, the method comprising:

receiving in a subframe of Pico cell, by the user equipment, the channel state information reference symbol or common reference symbol of the Pico cell, the subframe of Pico cell corresponding to an almost blank subframe in a measurement set; and

measuring the channel state information of the Pico cell based on the channel state information reference symbol or common reference symbol of the Pico cell.

According to another aspect of the some embodiments, user equipment configured with coordinated multi-point mode in a Macro cell is provided, the user equipment comprising:

a first receiving unit, configured to receive in a subframe of Pico cell the channel state information reference symbol or common reference symbol of the Pico cell, the subframe of Pico cell corresponding to the almost blank subframe in a measurement set; and

a first measuring unit, configured to measure the channel state information of the Pico cell based on the channel state information reference symbol or common reference symbol of the Pico cell.

According to still another aspect of the some embodiments, a method for measuring channel state information is provided, which is applied for user equipment configured with coordinated multi-point mode in a Pico cell, the method comprising:

receiving in a subframe of Macro cell, by the user equipment, the channel state information reference symbol or common reference symbol of the Macro cell, the subframe of Macro cell corresponding to the muted subframe of Pico cell in a measurement set; and

measuring the channel state information of the Macro cell based on the channel state information reference symbol or common reference symbol of the Macro cell.

According to further still another aspect of some embodiments, user equipment configured with coordinated multi-point mode in a Pico cell is provided, the user equipment comprising:

a second receiving unit, configured to receive in a subframe of Macro cell the channel state information reference symbol or common reference symbol of the Macro cell, the subframe of Macro cell corresponding to the muted subframe of Pico cell in a measurement set; and

a second measuring unit, configured to measure the channel state information of the Macro cell based on the channel state information reference symbol or common reference symbol of the Macro cell.

According to another aspect of some embodiments, a method for measuring channel state information is provided, which is applied for range expansion user equipment configured with coordinated multi-point mode in a Pico cell, the method comprising:

receiving in a subframe of Pico cell of a measurement set, by the user equipment, the channel state information reference symbol or common reference symbol of the Pico cell, the subframe of Pico cell corresponding to the almost blank subframe of a Macro cell; and

measuring the channel state information of the Pico cell base on the channel state information reference symbol or common reference symbol of the Pico cell.

According to further still another aspect of some embodiments, range expansion user equipment configured with coordinated multi-point mode in a Pico cell is provided, the user equipment comprising:

a third receiving unit, configured to receive in a subframe of Pico cell of a measurement set the channel state information reference symbol or common reference symbol of the Pico cell, the subframe of Pico cell corresponding to the almost blank subframe of a Macro cell; and

a third measuring unit, configured to measure the channel state information of the Pico cell base on the channel state information reference symbol or common reference symbol of the Pico cell.

According to further still another aspect of some embodiments, a method for measuring channel state information is provided, which is applied for a base station, the method comprising:

configuring by the base station a measurement set for user equipment belonging to the base station; and

transmitting the measurement set to the user equipment by using upper layer radio resource control signalling.

According to further still another aspect of some embodiments, a base station is provided, the base station comprising:

a fourth configuring unit, configured to configure a measurement set for the user equipment belonging to the base station; and

a first transmitting unit, configured to transmit the measurement set to the user equipment by using upper layer radio resource control signalling.

According to further still another aspect of some embodiments, a computer-readable program is provided, wherein when the program is executed in user equipment, the program enables the computer to carry out the method for measuring channel state information as described above in the user equipment.

According to further still another aspect of some embodiments, a storage medium is provided in which a computer-readable program is stored, wherein the computer-readable program enables the computer to carry out the method for measuring channel state information as described above in user equipment.

According to further still another aspect of some embodiments, a computer-readable program is provided, wherein when the program is executed in a base station, the program enables the computer to carry out the method for measuring channel state information as described above in the base station.

According to further still another aspect of some embodiments, a storage medium is provided in which a computer-readable program is stored, wherein the computer-readable program enables the computer to carry out the method for measuring channel state information as described above in a base station.

Some advantages of some embodiments exist in that by using a measurement set, user equipment configured with coordinated multi-point mode may measure channel state information of a Macro cell and a Pico cell when muting is not performed or muting is reduced, thereby overcoming or partially overcoming the problems brought by RE muting in a heterogeneous network.

In the description and drawings, particular embodiments have been disclosed in detail as being indicative of some of the ways in which some principles may be employed, but it is understood that the claimed invention is not limited correspondingly in scope. Rather, the claimed invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects can be better understood with reference to the following drawings. The components in the drawings are not necessarily to scale, emphasis instead being placed upon clearly illustrating the several principles. To facilitate illustrating and describing some parts of some embodiments, corresponding portions of the drawings may be exaggerated or decreased in size.

Elements and features depicted in one drawing or embodiment may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram showing the interference in a heterogeneous network;

FIG. 2 is a schematic diagram showing a typical CoMP structure;

FIG. 3 is a schematic diagram showing typical muting;

FIG. 4 is a schematic diagram showing the ABS configuration of a Macro cell;

FIG. 5A is a schematic diagram of an ABS subframe and a normal subframe;

FIG. 5B is a schematic diagram of a measurement set corresponding to FIG. 5A;

FIG. 6 is a flowchart of the method for measuring channel state information in a heterogeneous network of the embodiment 1;

FIG. 7A is a schematic diagram of the ABS subframe of a Macro cell of the embodiment 1;

FIG. 7B is a schematic diagram of the normal subframe of a Macro cell of the embodiment;

FIG. 8 is a structural schematic diagram of the user equipment configured with coordinated multi-point mode in a Macro cell of the embodiment 1;

FIG. 9 is a flowchart of the method for measuring channel state information in a heterogeneous network of the embodiment 2;

FIG. 10 is a schematic diagram of the range expansion user equipment and non-range expansion user equipment of a Pico cell in a heterogeneous network;

FIG. 11A is a schematic diagram of the subframe corresponding to ABS of a Pico cell;

FIG. 11B is a schematic diagram of the subframe corresponding to normal subframe of a Pico cell;

FIG. 12A is another schematic diagram of the subframe corresponding to ABS of a Pico cell;

FIG. 12B is another schematic diagram of the subframe corresponding to normal subframe of a Pico cell;

FIG. 13 is a structural schematic diagram of the user equipment configured with coordinated multi-point mode in a Pico cell of the embodiment 2;

FIG. 14 is a flowchart of the method for measuring channel state information in a heterogeneous network of the embodiment 3;

FIG. 15 is a structural schematic diagram of the range expansion user equipment configured with coordinated multi-point mode in a Pico cell of the embodiment 3;

FIG. 16 is a flowchart of the method for measuring channel state information in a heterogeneous network of the embodiment 4; and

FIG. 17 is a structural schematic diagram of the base station of the embodiment 4.

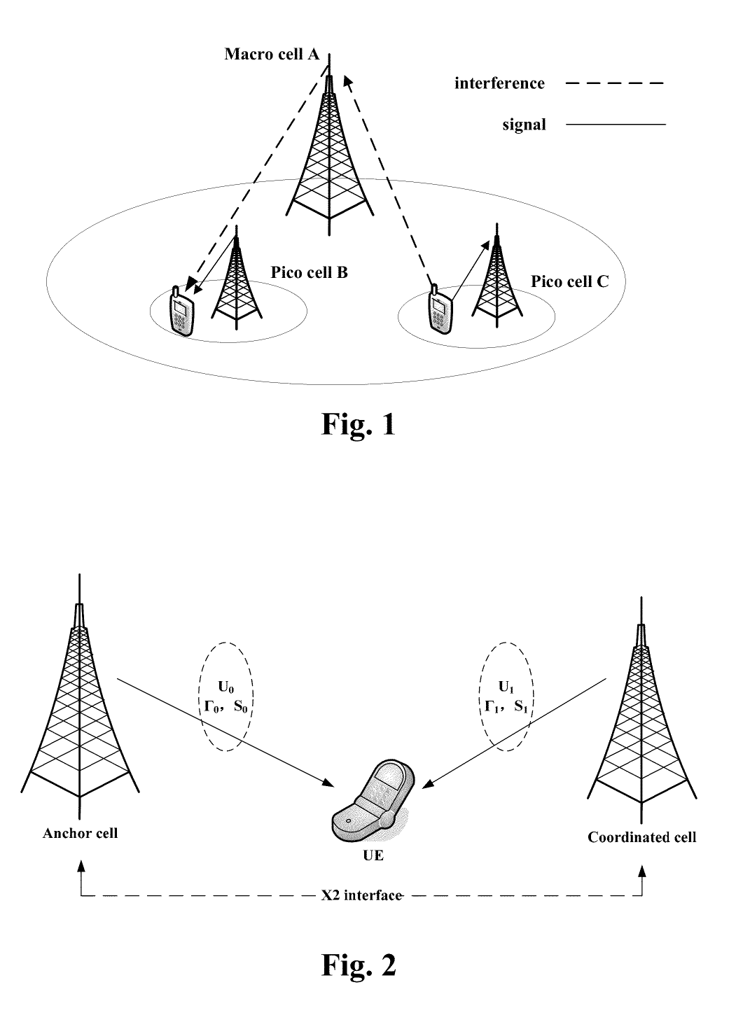

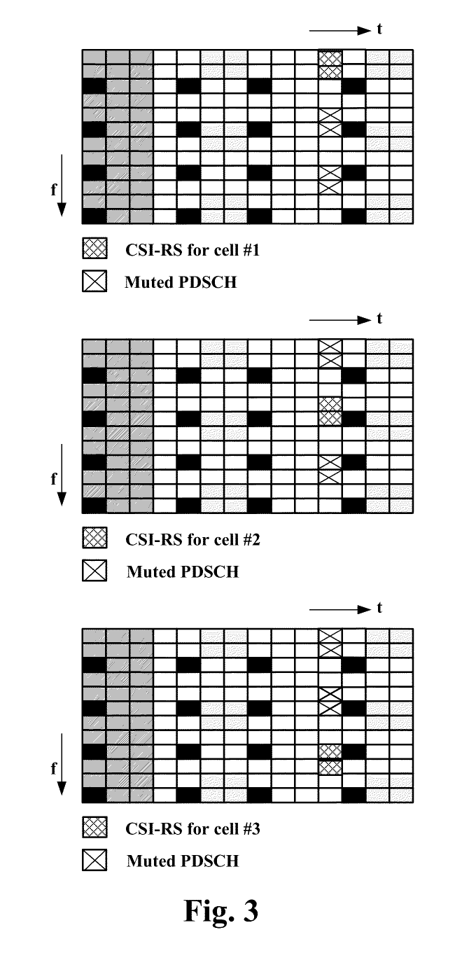

### DETAILED DESCRIPTION

The above and other features will be apparent through the following description with reference to the accompanying drawings. In the description and drawings, particular embodiments are disclosed, which indicate some ways of carrying out embodiments herein. It should be understood that the present claimed invention is not limited to the described embodiments. On the contrary, the claimed invention covers all the modifications, variants and equivalents falling within the scope of the appended claims.

Some embodiments shall be described taking measurement of channel station information in an LTE-A system as an example. However, it should be understood that the claimed invention is not limited to such a system, and it may be applicable to any system related to measurement of channel station information.

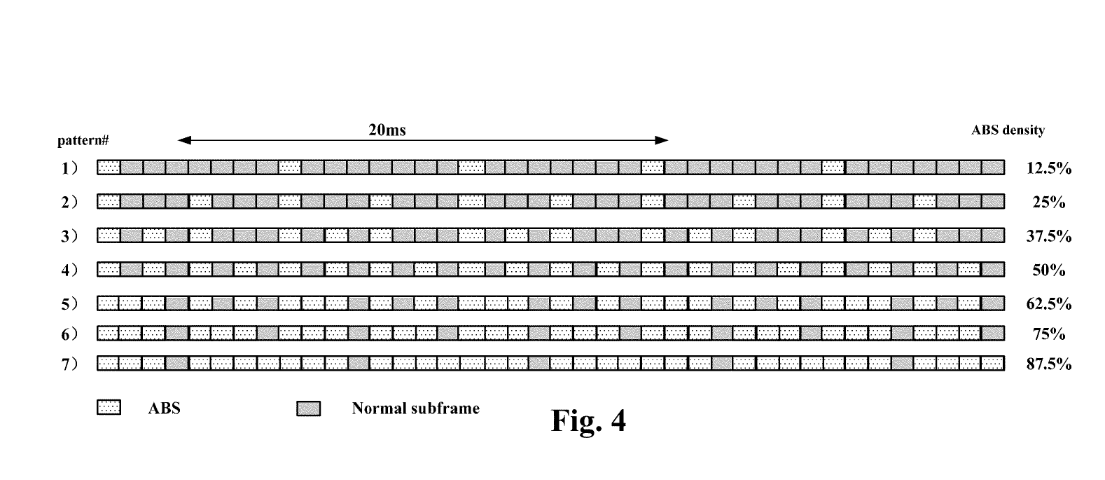

In the LTE-A, an almost blank subframe (ABS) scheme is used so as to solve the problem of interference of downlink signal from the Macro cell in a heterogeneous network. FIG. 4 is a schematic diagram showing the ABS configuration of a Macro cell. As shown in FIG. 4, some of the subframes in the Macro cell may be selected as ABS subframes, in which do not transmit control signalling scheduling data transmission of any UE, nor transmit data corresponding to any UE. The ABS subframes transmit only some necessary information, such as common reference symbols (CRSs).

Corresponding to the time position of the ABS subframe, the Pico cell may transmit control signaling scheduling UE data in the Pico cell and corresponding data, thereby suppressing interference from the Macro cell. The position of the ABS may be interacted by an X2 interface between the Macro cell and the Pico cell. A bitmap may be used in the interaction, the position in the bitmap corresponding to 0 (or 1) being a normal subframe, and position corresponding to 1 (or 0) being the ABS.

In this embodiment, as ABS is substantially different from a normal subframe (NSF), a measurement set (which may also be referred to as a measurement reference resource set) may be introduced for measuring channel station information.

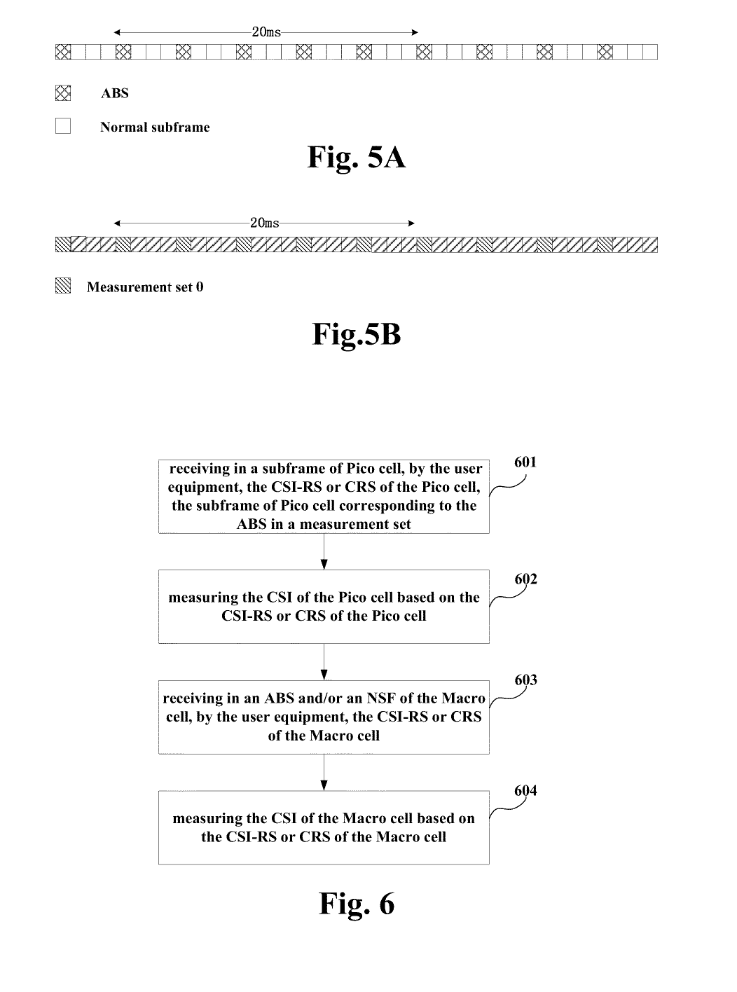

FIG. 5A is a schematic diagram of configuration of an ABS and an NSF, and FIG. 5B is a schematic diagram of a measurement set corresponding to FIG. 5A. Wherein the measurement set may be configured in the manner shown in FIG. 5B, for example, a measurement set 0 may be configured, which contains a plurality of ABSs.

A scheme of measurement of channel state information of a Macro cell and a Pico cell in a heterogeneous network shall be described by way of examples in detail below, on the basis of a measurement set and using a multi-point transmission solution. Wherein, the UE is configured with coordinated multi-point mode.

### Embodiment 1

An embodiment provides a method for measuring channel state information in a heterogeneous network, which shall be described in detail below taking that the UE is UE in the Macro cell configured with coordinated multi-point mode as an example.

FIG. 6 is a flowchart of the method for measuring channel state information in a heterogeneous network of an embodiment. As shown in FIG. 6, the method comprises:

step 601: receiving in a subframe of Pico cell, by the user equipment, the CSI-RS or CRS of the Pico cell, the subframe of Pico cell corresponding to the ABS in a measurement set; and

step 602: measuring the CSI of the Pico cell based on the CSI-RS or CRS of the Pico cell.

Furthermore, as shown in FIG. 6, the method may further comprise:

step 603: receiving in an ABS and/or an NSF of the Macro cell, by the user equipment, the CSI-RS or CRS of the Macro cell; and

step 604: measuring the CSI of the Macro cell based on the CSI-RS or CRS of the Macro cell.

In this embodiment, the measurement set may be configured by the base station to which the UE belongs, and is transmitted to the UE by using radio resource control (RRC) signalling; or the measurement set may be configured by the UE, and the UE learns the subframes contained in the measurement set by default.

In this embodiment, the measurement set may contain ABSs, or may contain ABSs and NSFs. For example, the measurement set contains ABSs only.

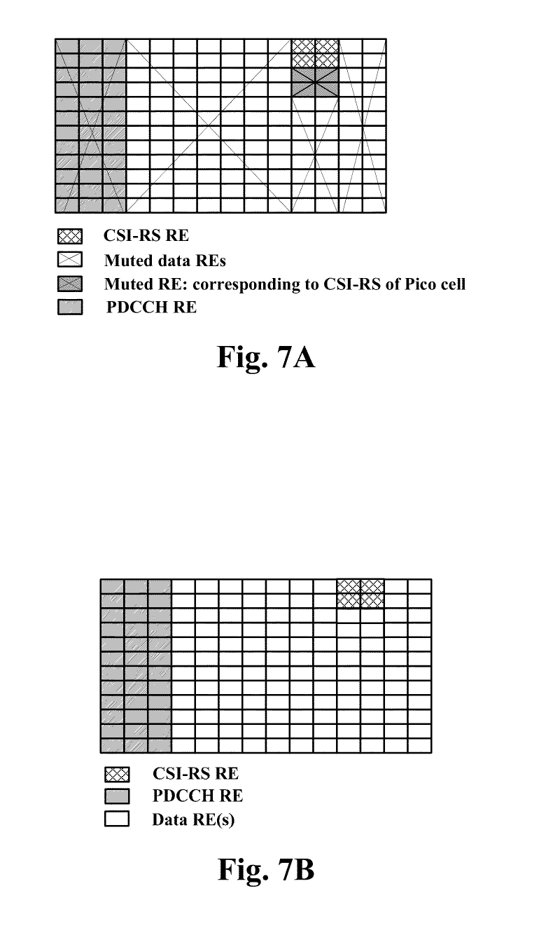

FIG. 7A is a schematic diagram of the ABS of a Macro cell, and FIG. 7B is a schematic diagram of the NSF of the Macro cell, which show respectively the structure of a RB containing an ABS having a CSI-RS and an NSF. It can be seen from FIGS. 7A and 7B, as no data transmission is contained in the ABS, that is, no data is transmitted at a position in the Macro cell corresponding to the CSI-RS or CRS of the Pico cell, it is equivalent to the RE muting.

Hence, the UE may correctly obtain CSI-RS or CRS from the ABS at a position corresponding to the CSI-RS or CRS of the Pico cell, so as to measure the CSI of the Pico cell. Therefore, no RE muting exists in the subframes of the Macro cell, thereby overcoming or partially overcoming the problems brought by RE muting.

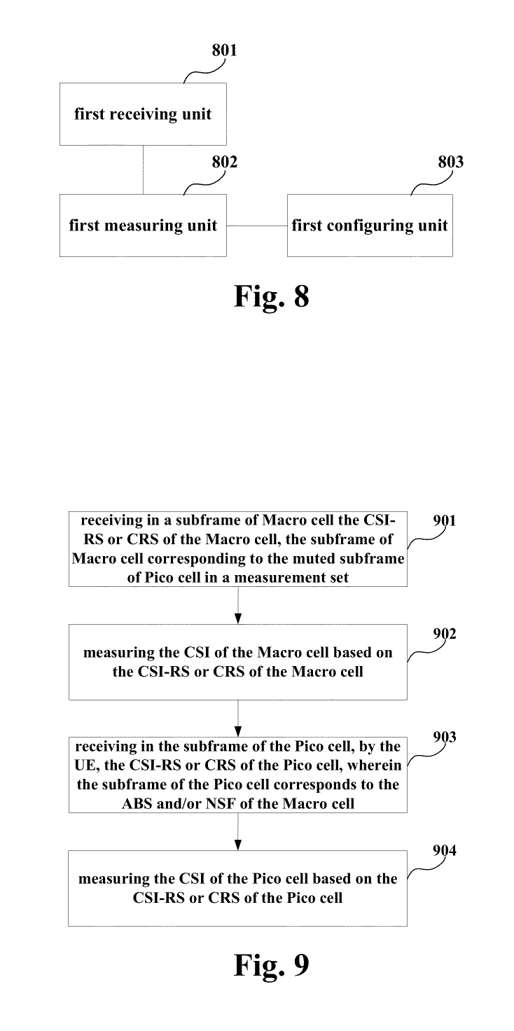

An embodiment provides UE configured with coordinated multi-point mode in a Macro cell. As shown in FIG. 8, the UE comprises: a first receiving unit 801 and a first measuring unit 802; wherein

the first receiving unit 801 is configured to receive in a subframe of Pico cell the CSI-RS or CRS of the Pico cell, the subframe of Pico cell corresponding to the ABS in a measurement set; and

the first measuring unit 802 is configured to measure the CSI of the Pico cell based on the CSI-RS or CRS of the Pico cell.

Furthermore, the first receiving unit 801 may be configured to receive the CSI-RS or CRS of the Macro cell in an ABS and/or an NSF of the Macro cell, and the first measuring unit 802 is configured to measure the CSI of the Macro cell based on the CSI-RS or CRS of the Macro cell.

In this embodiment, as shown in FIG. 8, the UE may further comprises a first configuring unit 803 configured to configure the measurement set, ABSs being contained in the measurement set, or ABSs and NSFs being contained in the measurement set.

It can be seen from the above embodiment that the UE configured with coordinated multi-point mode in the Macro cell may measure the CSI of the Macro cell and the Pico cell by using a measurement set without muting, thereby overcoming or partially overcoming the problems brought by RE muting.

### Embodiment 2

An embodiment provides a method for measuring channel state information, which shall be described in detail below taking that UE is non-range expansion UE configured with coordinated multi-point mode in a Pico cell as an example.

FIG. 9 is a flowchart of the method for measuring channel state information in a heterogeneous network of the embodiment. As shown in FIG. 9, the method comprises:

step 901: receiving in a subframe of Macro cell, by UE, the CSI-RS or CRS of the Macro cell, the subframe of Macro cell corresponding to the muted subframe of Pico cell in a measurement set; and

step 902: measuring the CSI of the Macro cell based on the CSI-RS or CRS of the Macro cell.

Furthermore, as shown in FIG. 9, the method may comprise:

step 903: receiving in the subframe of the Pico cell, by the UE, the CSI-RS or CRS of the Pico cell, wherein the subframe of the Pico cell corresponds to the ABS and/or NSF of the Macro cell; and

step 904: measuring the CSI of the Pico cell based on the CSI-RS or CRS of the Pico cell.

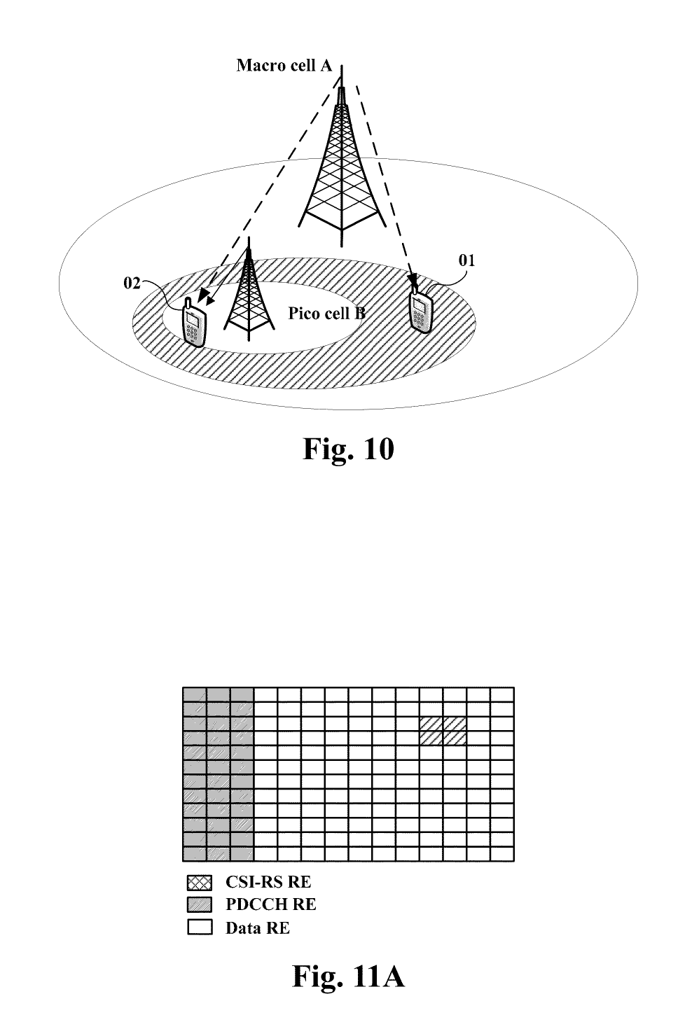

In this embodiment, the UE is non-range expansion UE in the Pico cell. FIG. 10 is a schematic diagram of the range expansion UE and non-range expansion UE of a Pico cell in a heterogeneous network.

As shown in FIG. 10, □ is the range expansion area. As the effects of such factors as the system capacity, etc., UE 01 belonging to a Macro cell A may be accessed into a Pico cell B and becomes a range expansion UE in the Pico cell. The data power from the Macro cell A that may be measured by the range expansion UE is generally higher than or much more higher than the data power from the Pico cell B. In this way, UE 02 belonging to Pico cell B is non-range expansion UE, which is less affected by the Macro cell A.

In this embodiment, the measurement set may be configured by the base station to which the UE belongs and is transmitted to the UE by using RRC signalling; or the measurement set may be configured by the UE, and the UE learns the subframes contained in the measurement set by default. Furthermore, the base station may notify the UE whether RE muting is performed in the subframe by using upper layer RRC signalling.

Particularly, in carrying out step 901, the muted subframe of the Pico cell corresponding to a NSF in the Macro cell is included in the measurement set. In the corresponding NSF of the Macro cell, the UE receives the CSI-RS or CRS of the Macro cell at the position of the CSI-RS or CRS, and measures the CSI of the Macro cell based on the CSI-RS or CRS of the Macro cell.

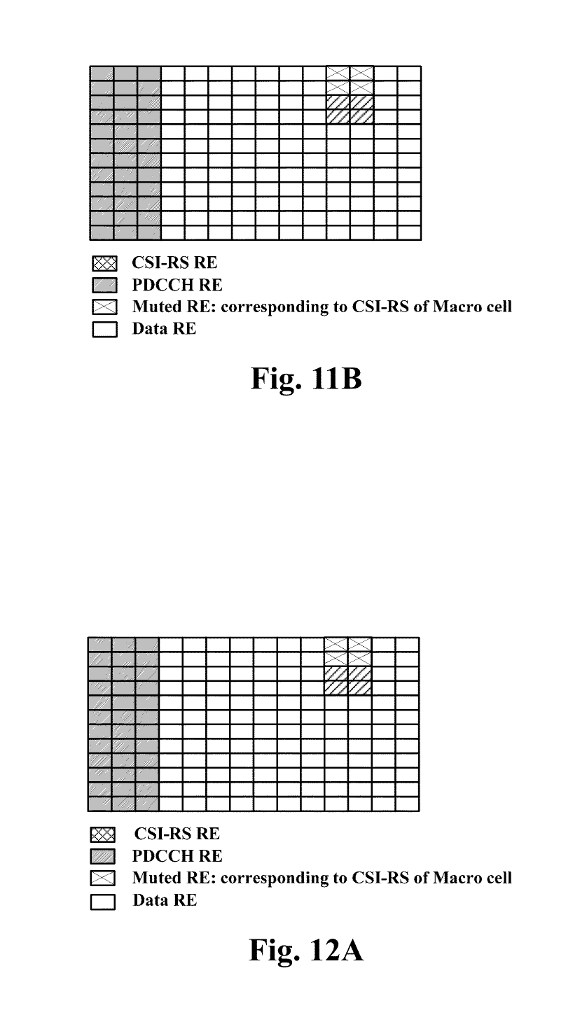

FIG. 11A is a schematic diagram of the subframe of a Pico cell, the subframe corresponds to ABS, and FIG. 11B is a schematic diagram of the subframe of the Pico cell, the subframe corresponds to NSF. It can be seen from FIGS. 11A and 11B that the subframes of the Pico cell are muted at the position corresponding to the CSI-RS or CRS in the NSF of the Macro cell, and the UE may correctly obtain the CSI-RS or CRS at a corresponding position in the NSF of the Macro cell, so as to measure the CSI of the Macro cell, thereby overcoming or partially overcoming the problems brought by RE muting.

Or, particularly, in carrying out step 901, the measurement set contains muted Pico cell subframe which corresponds to the ABS of the Macro cell. In the corresponding ABS of the Macro cell, the UE receives the CSI-RS or CRS of the Macro cell at the position of the CSI-RS or CRS, and measures the CSI of the Macro cell based on the CSI-RS or CRS of the Macro cell.

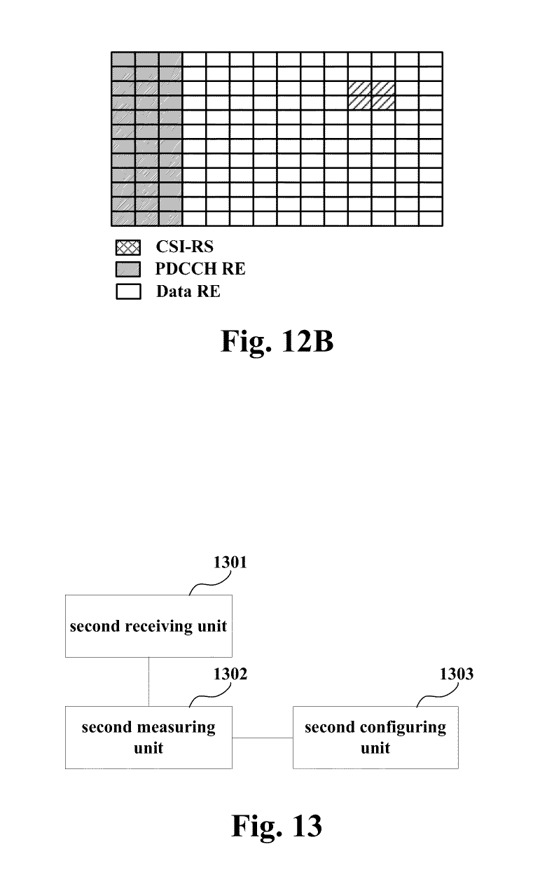

FIG. 12A is a schematic diagram of the subframe of a Pico cell, the subframe corresponds to ABS, and FIG. 12B is a schematic diagram of the subframe of the Pico cell, the subframe corresponds to NSF. It can be seen from FIGS. 12A and 12B that the subframes of the Pico cell are muted at the position corresponding to the CSI-RS or CRS in the ABS of the Macro cell, and the UE may correctly obtain the CSI-RS or CRS at a corresponding position in the ABS of the Macro cell, so as to measure the CSI of the Macro cell, thereby overcoming or partially overcoming the problems brought by RE muting.

An embodiment provides user equipment configured with coordinated multi-point mode in a Pico cell. As shown in FIG. 13, the UE comprises: a second receiving unit 1301 and a second measuring unit 1302; wherein

the second receiving unit 1301 is configured to receive in a subframe of Macro cell the CSI-RS or CRS of the Macro cell, the subframe of Macro cell corresponding to the muted subframe of Pico cell in a measurement set; and

the second measuring unit 1302 is configured to measure the CSI of the Macro cell based on the CSI-RS or CRS of the Macro cell.

Furthermore, the second receiving unit 1301 is further configured to receive in the subframe of Pico cell the CSI-RS or CRS of the Pico cell, wherein the subframe of the Pico cell corresponds to the ABS and/or NSF of the Macro cell;

and the second measuring unit 1302 is further configured to measure the CSI of the Pico cell based on the CSI-RS or CRS of the Pico cell.

In this embodiment, as shown in FIG. 13, the UE may further comprise: a second configuring unit 1303 configured to configure the measurement set; the muted subframe of Pico cell is included in the measurement set, the subframe of the Pico cell corresponding to the NSF of the Macro cell or corresponding to the ABS of the Macro cell.

It can be seen from the above embodiment that the non-range expansion UE configured with coordinated multi-point mode in the Pico cell may measure the CSI of the Macro cell and the Pico cell by using a measurement set with decreased muting, thereby overcoming or partially overcoming the problems brought by RE muting.

### Embodiment 3

An embodiment provides a method for measuring channel state information in a heterogeneous network, which shall be described in detail below taking that UE is range expansion UE configured with coordinated multi-point mode in a Pico cell as an example.

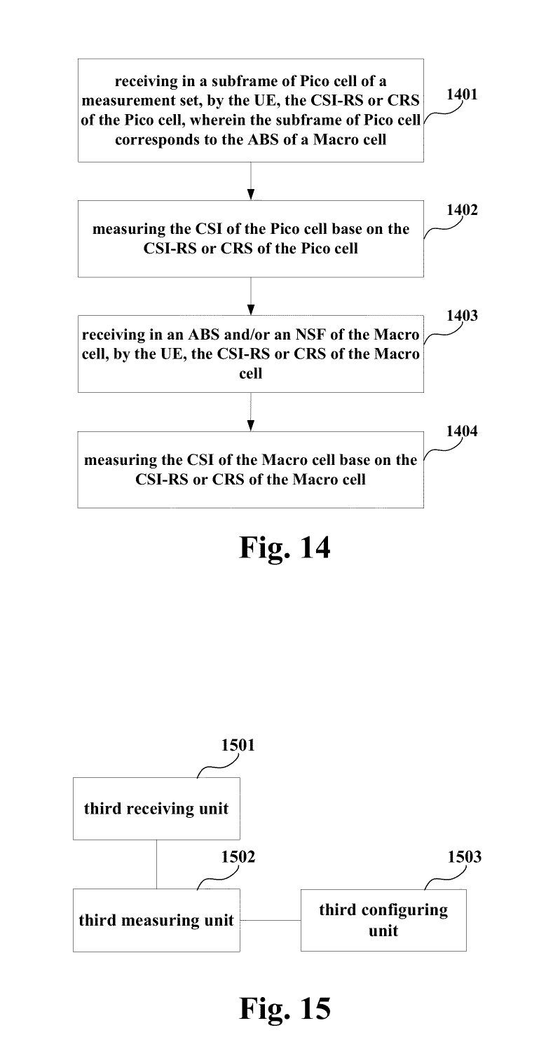

FIG. 14 is a flowchart of the method for measuring channel state information in a heterogeneous network of the embodiment. As shown in FIG. 14, the method comprises:

step 1401: receiving in a subframe of Pico cell of a measurement set, by the UE, the CSI-RS or CRS of the Pico cell, wherein the subframe of Pico cell corresponds to the ABS of a Macro cell; and

step 1402: measuring the CSI of the Pico cell base on the CSI-RS or CRS of the Pico cell.

Furthermore, as shown in FIG. 14, the method may further comprise:

step 1403: receiving in an ABS and/or an NSF of the Macro cell, by the UE, the CSI-RS or CRS of the Macro cell; and

step 1404: measuring the CSI of the Macro cell base on the CSI-RS or CRS of the Macro cell.

In this embodiment, the measurement set may be configured by the base station to which the UE belongs and is transmitted to the UE by using upper layer RRC signalling; or the measurement set may be configured by the UE, and the UE learns the subframes contained in the measurement set by default.

In this embodiment, particularly, in carrying out step 1401, the measurement set may contain muted Pico cell subframe which corresponds to the ABS of the Macro cell. As shown in FIGS. 12A and 12B, the UE may correctly obtain the CSI-RS or CRS in the Pico cell subframe corresponding to the ABS of the Macro cell, so as to measure the CSI of the Pico cell, thereby overcoming or partially overcoming the problems brought by RE muting.

Or, particularly, in carrying out step 1401, the measurement set may contain unmuted Pico cell subframe which corresponds to the ABS of the Macro cell. In the unmuted Pico cell subframe, the UE receives the CSI-RS or CRS of the Pico cell. Therefore, the CSI of the Pico cell may be measured without muting, thereby partially overcoming the problems brought by RE muting.

An embodiment provides range expansion UE configured with coordinated multi-point mode in a Pico cell. As shown in FIG. 15, the UE comprises: a third receiving unit 1501 and a third measuring unit 1502; wherein

the third receiving unit 1501 is configured to receive in a subframe of Pico cell of a measurement set the CSI-RS or CRS of the Pico cell, the subframe of Pico cell corresponding to the ABS of a Macro cell; and

the third measuring unit 1502 is configured to measure the CSI of the Pico cell base on the CSI-RS or CRS of the Pico cell.

Furthermore, the third receiving unit 1501 is further configured to receive the CSI-RS or CRS of the Macro cell in the ABS and/or an NSF of the Macro cell; and the third measuring unit 1502 is further configured to measure the CSI of the Macro cell based on the CSI-RS or CRS of the Macro cell.

In this embodiment, as shown in FIG. 15, the UE may further comprise a third configuring unit 1503 configured to configure the measurement set, the measurement set including the subframe of Pico cell corresponding to the ABS.

It can be seen from the above embodiment that the range expansion UE configured with coordinated multi-point mode in the Pico cell may measure the CSI of the Macro cell and the Pico cell by using a measurement set without muting or with decreased muting, thereby overcoming or partially overcoming the problems brought by RE muting.

### Embodiment 4

An embodiment provides a method for measuring channel state information in a heterogeneous network, which shall be described in detail below taking a base station as an example.

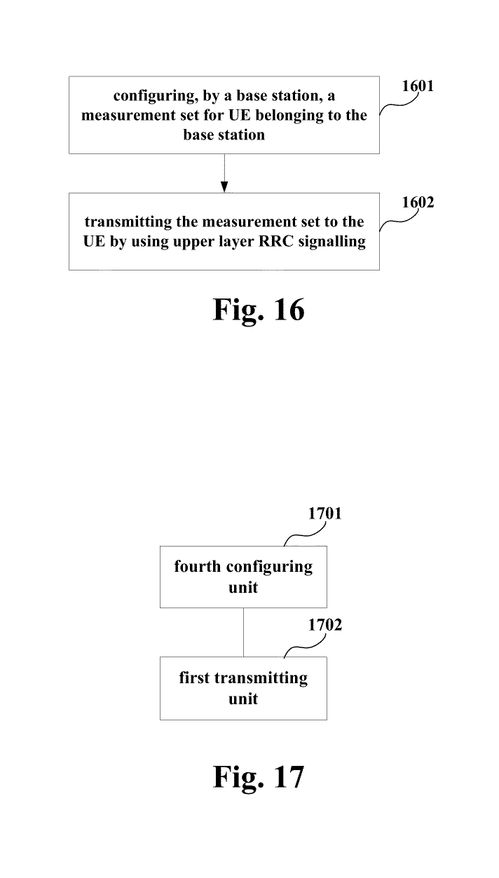

FIG. 16 is a flowchart of the method for measuring channel state information in a heterogeneous network of the embodiment. As shown in FIG. 16, the method comprises:

step 1601: configuring, by a base station, a measurement set for UE belonging to the base station; and

step 1602: transmitting the measurement set to the UE by using upper layer RRC signalling.

In this embodiment, the base station may be a Macro base station in a heterogeneous network, or may also be a Pico base station in a heterogeneous network. The measurement set contains ABSs of the Macro cell; or contains muted Pico cell subframes, the Pico cell subframes corresponding NSFs of the Macro cell, or corresponding to the ABSs of the Macro cell.

Particularly, when the base station is a Macro base station in a heterogeneous network, the measurement set contains ABS of the Macro cell. The Macro base station may transmit the measurement set to the UE configured with coordinated multi-point mode in the Macro cell by using upper layer RRC signalling, so that the UE measures the CSI of the Macro cell and the Pico cell without muting by using the measurement set.

Or, when the base station is a Pico base station in a heterogeneous network, the measurement set contains muted subframes of the Pico cell, the subframes of the Pico cell corresponding to the NSFs of the Macro cell, or corresponding to the ABSs of the Macro cell. The Pico base station may transmit the measurement set to the UE configured with coordinated multi-point mode in the Pico cell (including range expansion equipment and non-range expansion equipment) by using upper layer RRC signalling, so that the UE measures the CSI of the Macro cell and the Pico cell without muting or with decreased muting by using the measurement set.

An embodiment further provides a base station. As shown in FIG. 17, the base station comprises: a fourth configuring unit 1701 and a first transmitting unit 1702; wherein

the fourth configuring unit 1701 is configured to configure a measurement set for the UE to which it belongs; wherein the measurement set contains ABS of a Macro cell, or muted subframe of a Pico cell, the subframe of the Pico cell corresponding to the NSF of the Macro cell, or corresponding to the ABS of the Macro cell; and

the first transmitting unit 1702 is configured to transmit the measurement set to the UE by using upper layer RRC signalling.

It can be seen from the above embodiment that the base station configures the measurement set for the UE to which it belongs, so that the UE measures the CSI of the Macro cell and the Pico cell without muting or with decreased muting by using the measurement set, thereby overcoming or partially overcoming the problems brought by RE muting.

An embodiment provides a computer-readable program, wherein when the program is executed in UE, the program enables the computer to carry out the method for measuring channel state information as described in embodiments 1-3 in the UE.

An embodiment provides a storage medium in which a computer-readable program is stored, wherein the computer-readable program enables the computer to carry out the method for measuring channel state information as described in embodiments 1-3 in UE.

An embodiment provides a computer-readable program, wherein when the program is executed in a base station, the program enables the computer to carry out the method for measuring channel state information as described in embodiment 4 in the base station.

An embodiment provides a storage medium in which a computer-readable program is stored, wherein the computer-readable program enables the computer to carry out the method for measuring channel state information as described in embodiment 4 in a base station.

The above apparatuses and methods may be implemented by hardware, or by hardware in combination with software. Certain embodiments also relate to such a computer-readable program that when the program is executed by a logic device, the logic device is enabled to carry out the apparatus or components as described above, or to carry out the methods or steps as described above. Certain embodiments also relate to a storage medium for storing the above program, such as a hard disk, a floppy disk, a CD, a DVD, and a flash memory, etc.

Certain embodiments are described above in connection with particular features. However, those skilled in the art should be understood that such description is illustrative only, and is not intended to limit the protection scope of the claimed invention. Various variants and modifications may be made by those skilled in the art in accordance with the spirits and principle of the claimed invention, and such variants and modifications fall within the scope of the present claimed invention.

1. A method for measuring channel state information, which is applied for user equipment configured with coordinated multi-point mode in a Macro cell, the method comprising:
receiving in a subframe of Pico cell, by the user equipment, the channel state information reference symbol or common reference symbol of the Pico cell, the subframe of Pico cell corresponding to an almost blank subframe in a measurement set; and
measuring the channel state information of the Pico cell based on the channel state information reference symbol or common reference symbol of the Pico cell.

2. The method according to claim 1, wherein the method further comprises:
receiving in an almost blank subframe and/or a normal subframe of the Macro cell, by the user equipment, the channel state information reference symbol or common reference symbol of the Macro cell; and
measuring the channel state information of the Macro cell based on the channel state information reference symbol or common reference symbol of the Macro cell.

3. The method according to claim 1, wherein the measurement set is configured by the base station to which the user equipment belongs and is transmitted to the user equipment by using upper layer radio resource control signalling; or the measurement set is configured by the user equipment.

4. User equipment configured with coordinated multi-point mode in a Macro cell, comprising:
a first receiving unit, configured to receive in a subframe of Pico cell the channel state information reference symbol or common reference symbol of the Pico cell, the subframe of Pico cell corresponding to the almost blank subframe in a measurement set; and
a first measuring unit, configured to measure the channel state information of the Pico cell based on the channel state information reference symbol or common reference symbol of the Pico cell.

5. The user equipment according to claim 4, wherein the first receiving unit is further used to receive the channel state information reference symbol or common reference symbol of the Macro cell in an almost blank subframe and/or a normal subframe of the Macro cell; and
the first measuring unit is further used to measure the channel state information of the Macro cell based on the channel state information reference symbol or common reference symbol of the Macro cell.

6. The user equipment according to claim 4, wherein the user equipment further comprises:
a first configuring unit, configured to configure the measurement set, wherein an almost blank subframe being included in the measurement set.

7. A method for measuring channel state information, which is applied for user equipment configured with coordinated multi-point mode in a Pico cell, the method comprising:
receiving in a subframe of Macro cell, by the user equipment, the channel state information reference symbol or common reference symbol of the Macro cell, the subframe of Macro cell corresponding to the muted subframe of Pico cell in a measurement set; and
measuring the channel state information of the Macro cell based on the channel state information reference symbol or common reference symbol of the Macro cell.

8. The method according to claim 7, wherein the method further comprises:
receiving in the subframe of the Pico cell, by the user equipment, the channel state information reference symbol or common reference symbol of the Pico cell, wherein the subframe of the Pico cell corresponds to an almost blank subframe and/or a normal subframe of the Macro cell; and
measuring the channel state information of the Pico cell based on the channel state information reference symbol or common reference symbol of the Pico cell.

9. The method according to claim 7, wherein the measurement set is configured by the base station to which the user equipment belongs and is transmitted to the user equipment by using upper layer radio resource control signalling; or
the measurement set is configured by the user equipment.

10. The method according to claim 7, wherein the muted subframe of Pico cell corresponding to normal subframe of Macro cell is included in the measurement set.

11. The method according to claim 7, wherein the muted subframe of Pico cell corresponding to almost blank subframe of Macro cell is included in the measurement set.

12. User equipment configured with coordinated multi-point mode in a Pico cell, comprising:
a second receiving unit, configured to receive in a subframe of Macro cell the channel state information reference symbol or common reference symbol of the Macro cell, the subframe of Macro cell corresponding to the muted subframe of Pico cell in a measurement set; and
a second measuring unit, configured to measure the channel state information of the Macro cell based on the channel state information reference symbol or common reference symbol of the Macro cell.

13. The user equipment according to claim 12, wherein the second receiving unit is further used to receive in the subframe of Pico cell the channel state information reference symbol or common reference symbol of the Pico cell, wherein the subframe of the Pico cell corresponds to an almost blank subframe and/or a normal subframe of the Macro cell; and
the second measuring unit is further used to measure the channel state information of the Pico cell based on the channel state information reference symbol or common reference symbol of the Pico cell.

14. The user equipment according to claim 12, wherein the user equipment further comprises:
a second configuring unit, configured to configure the measurement set, the muted subframe of Pico cell included in the measurement set corresponding to the normal subframe of the Macro cell or corresponding to the almost blank subframe of the Macro cell.

15. A method for measuring channel state information, which is applied for range expansion user equipment configured with coordinated multi-point mode in a Pico cell, the method comprising:
receiving in a subframe of Pico cell of a measurement set, by the user equipment, the channel state information reference symbol or common reference symbol of the Pico cell, the subframe of Pico cell corresponding to the almost blank subframe of a Macro cell; and
measuring the channel state information of the Pico cell base on the channel state information reference symbol or common reference symbol of the Pico cell.

16. The method according to claim 15, wherein the method further comprises:
receiving in an almost blank subframe and/or a normal subframe of the Macro cell, by the user equipment, the channel state information reference symbol or common reference symbol of the Macro cell; and
measuring the channel state information of the Macro cell base on the channel state information reference symbol or common reference symbol of the Macro cell.

17. The method according to claim 15, wherein the measurement set is configured by the base station to which the user equipment belongs and is transmitted to the user equipment by using upper layer radio resource control signalling; or the measurement set is configured by the user equipment.

18. Range expansion user equipment configured with coordinated multi-point mode in a Pico cell, comprising:
a third receiving unit, configured to receive in a subframe of Pico cell of a measurement set the channel state information reference symbol or common reference symbol of the Pico cell, the subframe of Pico cell corresponding to an almost blank subframe of a Macro cell; and
a third measuring unit, configured to measure the channel state information of the Pico cell base on the channel state information reference symbol or common reference symbol of the Pico cell.

19. The user equipment according to claim 18, wherein the third receiving unit is further used to receive the channel state information reference symbol or common reference symbol of the Macro cell in an almost blank subframe and/or a normal subframe of the Macro cell; and
the third measuring unit is further used to measure the channel state information of the Macro cell based on the channel state information reference symbol or common reference symbol of the Macro cell.

20. The user equipment according to claim 18, wherein the user equipment further comprises:
a third configuring unit, configured to configure the measurement set, the measurement set including the subframe of Pico cell corresponding to the almost blank subframe.

21. A method for measuring channel state information, which is applied for a base station, the method comprising:
configuring, by the base station, a measurement set for user equipment belonging to the base station; and
transmitting the measurement set to the user equipment by using upper layer radio resource control signalling.

22. The method according to claim 21, wherein the measurement set includes an almost blank frame or a muted subframe of Pico cell, the subframe of Pico cell corresponding to normal subframe of almost blank subframe of a Macro cell.

23. A base station, comprising:
a fourth configuring unit, configured to configure a measurement set for the user equipment; and
a first transmitting unit, configured for transmitting the measurement set to the user equipment by using upper layer radio resource control signalling.

24. A computer-readable program, wherein when the program is executed in user equipment, the program enables the user equipment to carry out the method of claim 1 for measuring channel state information in the user equipment.

25. A storage medium in which a computer-readable program is stored, wherein the computer-readable program enables a computer to carry out the method of claim 1, of measuring channel state information in user equipment.

26. A computer-readable program, wherein when the program is executed in a base station, the program enables the base station to carry out the method of claim 21 of measuring channel state information in the base station.

27. A storage medium in which a computer-readable program is stored, wherein the computer-readable program when executed enables a computer to carry out the method of claim 21 for measuring channel state information in a base station.
